(19) United States
(12) Patent Application Publication
(10) Pub. No.: US 2023/0351707 A1
(43) Pub. Date: Nov. 2, 2023

(54) AUGMENTED REALITY AND EDIBLE ELEMENT-BASED INTERACTIVE READING SYSTEM AND METHOD

(71) Applicant: Jacqueline García, Thousand Oaks, CA (US)

(72) Inventor: Jacqueline García, Thousand Oaks, CA (US)

(21) Appl. No.: 18/140,579

(22) Filed: Apr. 27, 2023

Related U.S. Application Data
(60) Provisional application No. 63/363,787, filed on Apr. 28, 2022.

(51) Int. Cl. G06T 19/00; G06V 10/20

(52) U.S. Cl. CPC G06T 19/006; G06V 10/255; G06T 2207/30204

(57) ABSTRACT

Aspects of the disclosed technology generally relate to the field of education and entertainment technology and in particular, to augmented reality (AR) technology and edible element-based interactive reading systems and methods. A process of the disclosed technology can include steps for launching an AR software application stored on an electronic device, wherein the AR software application is configured to interact with a book comprising one or more augmented reality (AR) markers and one or more edible elements embedded within the pages of the book and generating, based on the one or more AR markers, one or more AR characters, wherein the one or more AR characters are overlayed over the book. The process can further include steps for generating an animated reaction of the one or more AR characters when the one or more edible elements are removed.

### CROSS-REFERENCE TO RELATED APPLICATIONS

The present application claims the benefit of U.S. Provisional Application No. 63/363,787, filed on Apr. 28, 2022, which is hereby incorporated by reference in its entirety.

### BACKGROUND

### 1. Technical Field

The present disclosure generally relates to the field of education and entertainment technology and in particular, to augmented reality (AR) technology and edible element-based interactive reading systems and methods.

### 2. Introduction

Children' s books that include pictures offer numerous benefits for young readers. One of the advantages is they help engage a child's attention and hold their interest. Pictures provide visual cues that aid in comprehension and reinforce the meaning and context of the associated text. They also help create a more immersive reading experience by enabling children to visualize the characters, settings, and events in the story. In addition to pictures, modern children's books may contain additional varieties of interactive elements that help engage young readers and enhance their reading experience.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example edible element reading system, according to some aspects of the disclosed technology.

FIG. 2 illustrates an example augmented reality and edible element reading system, according to some aspects of the disclosed technology.

FIG. 3 illustrates an example of a process for implementing an augmented reality and edible element reading system, according to some aspects of the disclosed technology.

FIG. 4 illustrates another example of a process for implementing an augmented reality and edible element reading system, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Children's books with different types of interactive elements, such as lift-the-flaps, pop-ups, sound buttons, augmented reality (AR), and interactive illustrations, can greatly enhance a child's reading experience. These interactive elements may add a new dimension to the reading experience, making it more engaging, exciting, and memorable. They may encourage children to actively participate in the story, to use their senses and imagination, and to explore different concepts and ideas. Interactive elements can also improve a child's cognitive skills, such as problem-solving, attention, and memory, by requiring them to engage with the story in a more interactive way. Additionally, these elements can foster a love of reading and learning, as children are more likely to want to read books that are fun and interactive. Children's books with different types of interactive elements may provide a unique and enriching reading experience, which can have a lasting impact on a child's development and education.

Augmented reality (AR) can be used with a cell phone or tablet PC to enhance a children's book by adding an interactive and immersive digital layer to the reading experience. In some examples, AR may be used with a children's book by a software application (e.g., stored on an electronic device) that is specifically designed for the book. The app may use the device's (e.g., cell phone, tablet PC, computer, laptop) camera to recognize specific images in the book, such as illustrations or characters and may overlay digital content onto the real-world image. For example, if a child is reading a book about animals, the AR app may recognize a picture of a lion in the book and display a 3D animation of a lion roaring on the screen. In some embodiments, if the book is about a character going on an adventure, the app may show an interactive map that allows the child to follow the character's journey. In some aspects, AR with a children's book can make the reading experience more engaging and interactive, as children can see and interact with digital content related to the story in real-time. In some examples, it may also help to develop children's visual and spatial skills, as well as their understanding of technology. In some cases, AR may provide a means for children to learn and explore different concepts and ideas and add a new dimension to the reading experience while inspiring a love of reading and learning.

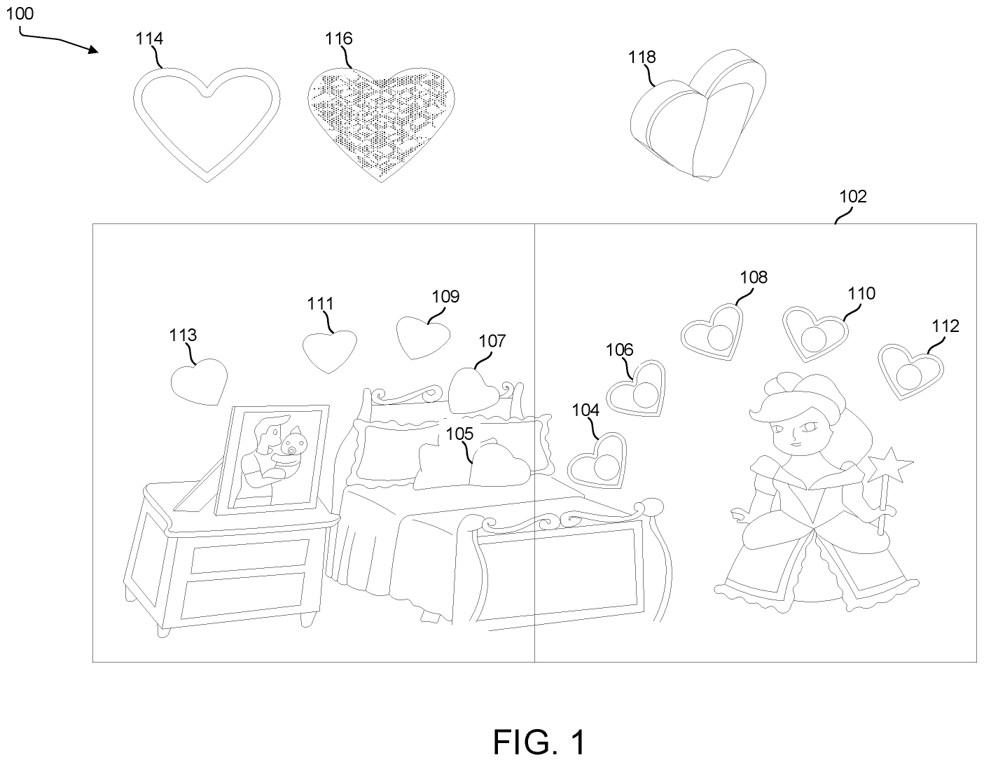

FIG. 1 illustrates an example edible element reading system 100, according to some aspects of the disclosed technology. In the example as illustrated in FIG. 1, children's book 102 may include one or more edible elements (e.g., first edible element 104, second edible element 106, third edible element 108, fourth edible element 110, fifth edible element 112) in one or more locations on a page (e.g., children's book 102 as illustrated in FIG. 1 is opened and showing two pages in the interior of the book). As shown in FIG. 1, top view edible element 114 illustrates the front or top view of the edible element that may be seen by a viewer of children's book 102. Rear view edible element 116 illustrates the back or rear view of the edible element which may include an adhesive material (e.g., which may be visible after removing a backing paper) that may be used to attach the edible element to a page or location on children's book 102. Second rear view edible element 118 illustrates an adhesive label attached to the edible element showing a backing paper partially removed with the adhesive layer underneath. In addition to the adhesive material, other methods may be used to attach edible elements to pages of a book including, but not limited to, glue, double-sided tape, food-grade adhesive, and plastic wrap. Those skilled in the art will appreciate additional methods of attaching edible elements to pages of a book.

In some aspects, examples of edible elements may include various types of candy or confectionary including, but not limited to, chocolate, gummy, hard candy, sour candy, taffy, licorice, or any other type of edible material safe for consumption and suitable for attaching to a surface (e.g., to a page on children's book 102). As illustrated in FIG. 1, the edible elements (e.g., first edible element 104, second edible element 106, third edible element 108, fourth edible element 110, fifth edible element 112) may be heart-shaped or any other shape or design (e.g., shape, color, pattern, consistency, material). In some examples, as illustrated in FIG. 1, children's book 102 may be a book for young readers or children or any other type of paper reading material including, but not limited to, books (e.g., of any genre for any age range), magazines, newspapers, brochures, pamphlets, journals, publications, comics, graphic novels, catalogs, and product manuals.

As shown in FIG. 1, each edible element may include a corresponding cut-out region such that one or more edible elements are visible in multiple pages of children's book 102. For example, first edible element 104 has corresponding first cut-out region 105, second edible element 106 has corresponding second cut-out region 107, third edible element 108 has corresponding third cut-out region 109, fourth edible element 110 has corresponding fourth cut-out region 111 and fifth edible element 112 has corresponding fifth cut-out region 113. For example, consider the depiction of children's book 102 as illustrated in FIG. 1 as the first and second page of the book and the prior page as the cover of children's book 102. In this example, all five edible elements (e.g., edible elements 104, 106, 108, 110, 112) may be visible when viewing the cover of children's book 102. In other words, the five cut out regions (e.g., cut-out regions 105, 107, 109, 111, 113) are regions where there is no physical material on the page (e.g., no paper material which results in hollow surface areas) such that when the page is turned back to the cover page of children's book 102, each edible element is able to pass through each cut out region and is visible and accessible by the reader, viewer or user of children's book 102.

In another example, when viewing other pages of children's book 102 (e.g., pages before or after the pages as illustrated in FIG. 1), one or more edible elements and one or more corresponding cut-out regions may be removed. For example, as illustrated above, the pages as shown in FIG. 1 may be pages 1 and 2 of children's book 102 (e.g., the previous page may be the cover of children's book 102). When turning the page of children's book 102, the next two pages (not illustrated) may be pages 3 and 4 of children's book 102. In some aspects, when viewing pages 3 and 4, one or more edible elements and corresponding cut-out regions may be removed. For example, in pages 3 and 4 of children's book 102, first edible element 104 and corresponding first cut-out region 105 may be removed. In other words, first edible element 104 may be attached to page 2 of children's book 102 and on page 3 and page 4 first edible element 104 and first cut-out region 105 may no longer be present (e.g., on page 3 and 4 of children's book 102, only 4 edible elements 106, 108, 110, 112 and corresponding cut-out regions 107, 109, 111, 133 may remain). In addition, on page 5 and page 6 (not illustrated) of children's book 102, only 3 edible elements (e.g., edible elements 108, 110, 112) and corresponding cut-out regions (e.g., cut-out regions 109, 111, 113) may be present. In other words, third edible element 106 may be attached to page 4 such that on page 6 only edible elements 108, 110 and 112 remain and only corresponding cut-out regions 109, 111 and 113 remain. Each page of children's book 102 may have a different number of edible elements and corresponding cut-out regions.

In some instances, when an edible element is removed (e.g., removed and consumed by the user of children's book 102), it may be replaced. For example, as shown in FIG. 1, first rear view edible element 116 and second rear view edible element 118 may include a backing paper such that when removed, an adhesive material is on the edible element so it may be attached to children's book 102 (e.g., if any edible element 104, 106, 108, 110, 112 is consumed, then a new edible element may be re-attached to the same location).

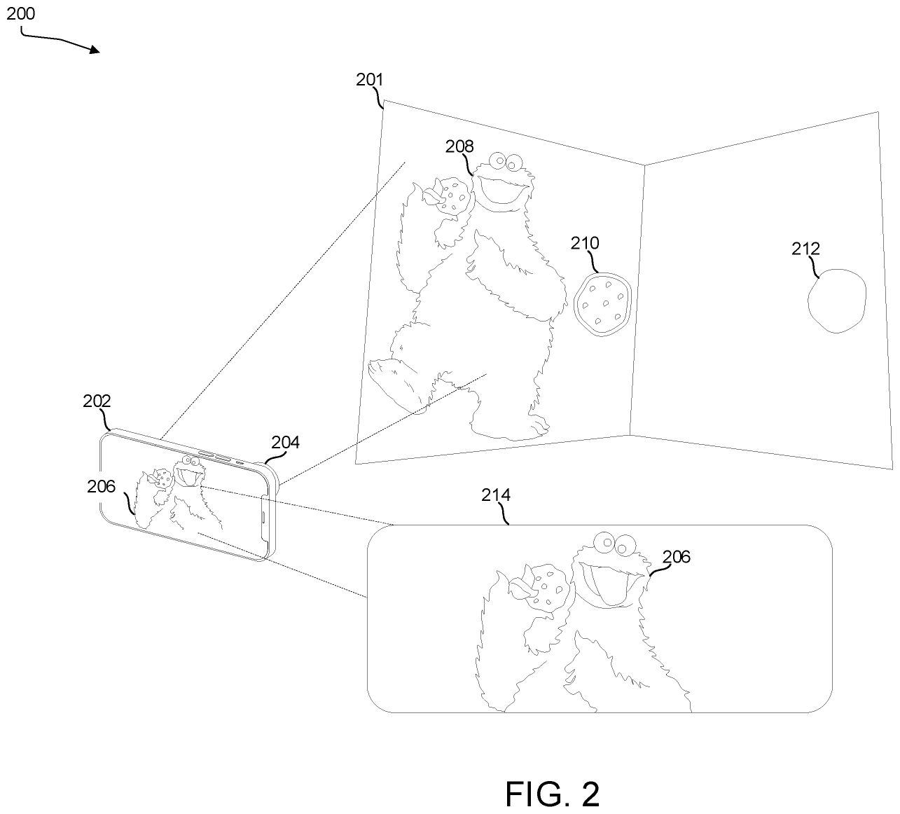

FIG. 2 illustrates an example augmented reality (AR) and edible element reading system 200, according to some aspects of the disclosed technology. As shown in FIG. 2, electronic device 202 may point its camera 204 to children's book 201. As discussed above in FIG. 1, children's book 201 may include any other type of paper reading material including, but not limited to, books (e.g., of any genre for any age range), magazines, newspapers, brochures, pamphlets, journals, publications, comics, graphic novels, catalogs, product manuals, puzzles, coloring books, immersive reality books, and scratch and sniff books. Examples of electronic device 202 may include, but are not limited to, a cell phone, laptop, tablet PC, smart glasses, and a smart watch (e.g., electronic device 202 may be any device with a camera, processor, and display). In some cases, electronic device 202 may have each of its components separated into separate units (e.g., the camera may be one device, the processor another device such as a computer, the display another device such as a monitor). In some aspects, electronic device 202 may include an application (e.g., software application) that is compatible with children's book 201. In other words, the application stored on electronic device 202 may enable an augmented reality experience with children's book 201. In some examples, children's book 201 may be compatible with virtual reality (VR) headsets, 3D, and merged reality. The software application may be downloaded (e.g., via the internet), installed via a wired connection (e.g., electronic device 202 may be connected with a data cable to another device), pre-installed, or received via a wireless transmission (e.g., Bluetooth, near field communication, Wi-Fi, Airdrop, etc.). Those skilled in the art will appreciate additional examples of how a software application for AR may be stored on electronic device 202.

In some aspects, once the AR software application is launched, a user may point the camera 204 of electronic device 202 towards children's book 201. The AR software application may recognize or identify markers or images on a page that may trigger AR content. For example, the AR software application may recognize character 208 in children' s book 201 or another marker (not illustrated) on a page and launch a corresponding AR character 206. There may be one or more markers on a page that trigger different types of AR content (e.g., a first character on a page may trigger a first AR character while a second character on a page may trigger AR content for the second character). Examples of markers may include, but are not limited to, a character, image, pattern, QR code, or any type of image or visual marker that is configured to be recognized by the AR software application.

When the AR content is recognized (e.g., the AR software application has identified a marker), the AR software application may overlay content on top of the children's book 201 page. For example, AR character 206 as shown on screen 214 of electronic device 202 may be overlayed on top of children's book 201. In other words, when viewing screen 214, AR character 206 may be seen as a three-dimensional (3D) animation directly above the corresponding character 208 in children's book 201. As discussed above there may be one or more AR characters 206 (e.g., different animations and different characters) on any page in children's book 201. In some examples, AR character 206 can be an animated representation of the equivalent character 208 in children's book 201, where AR character 206 when viewed through screen 214 may be seen as an animation directly above character 208 or any other location (e.g., another location on the pages of children's book 201) where electronic device 202 is pointing. In some cases, AR character 206 may produce audio content (e.g., speech, sounds, music, songs) and the AR software application may also produce audio content. In some examples, the audio content may be received by the user via the speakers of electronic device 202 or transmitted wirelessly (e.g., heard via headphones or a remote speaker). In some instances, the user may interact with the AR character 206 using the AR software application. For example, the user may tap or swipe screen 214 or use other gestures to control AR character 208. The user may also speak or produce audio content which may be recognized by the AR software application and cause AR character 208 to react to the received audio content. In another example, if electronic device 202 is a set of smart glasses, the user may view AR character 208 through the lenses of the smart glasses and interact with AR character 208 via blinking patterns or eye gestures.

In some aspects, children's book 201 may include one or more edible elements 210. As discussed above, the edible element 210 may be a confectionary such as candy or any type of edible material safe for consumption. In some examples, there may be a sensor underneath edible element 210 attached to children's book 201 capable of detecting the presence of edible element 210. In other words, there may be a sensor in region 212 where edible element 210 is stored such that when edible element 210 is removed as shown in region 212, a sensor in region 212 detects that edible element 210 is no longer present. Examples of sensor types may include, but are not limited to, magnetic sensors, pressure sensors, optical sensors, capacitive sensors, and RFID sensors. Those skilled in the art will appreciate additional types of sensors that may be used to detect the presence of edible element 210. In some instances, when edible element 210 is removed (e.g., consumed by the user of children's book 201), the AR character 206 may respond or react. For example, AR character 206 may provide audio commentary to the user or a new animation may be generated by AR character 206 based on the removal of edible element 210. As discussed above in FIG. 1, edible element 210 may be replaced after consumption or use with another edible element 210. In some cases, there may be one or more variations (e.g., different types of edible elements) attached to children's book 201.

In some instances, the AR software application may produce audio content in any language including, but not limited to, English, Japanese, Korean, Hindi, Russian, Spanish, Mandarin, Arabic, Portuguese, Tagalog, or any other language. The AR software application may also include a menu that allows the user to order more edible elements 210. In some aspects, the AR software application may also include narration (e.g., audio narration of children's book 201), games, one or more characters, one or more character animations, games, and character customizations (e.g., the user can modify the aesthetic characteristics of AR character 206 such as a change of clothing, color, style, etc.). In some cases, AR software application may include e-book capabilities such as an electronic version of children's book 201. In some instances, AR software application may include hologram capabilities and may display hologram animations and images via electronic device 202 (e.g., electronic device 202 may output a hologram such as AR character 206). In some cases, the AR software app may allow AR characters 206 to be personalized by changing the design of the AR character 206 such as basing the design on a photo (e.g., designing AR character 206 based on a photograph stored on electronic device 202) or modifying other characteristics of AR character 206 (e.g., changing the clothes, style, character model, etc.).

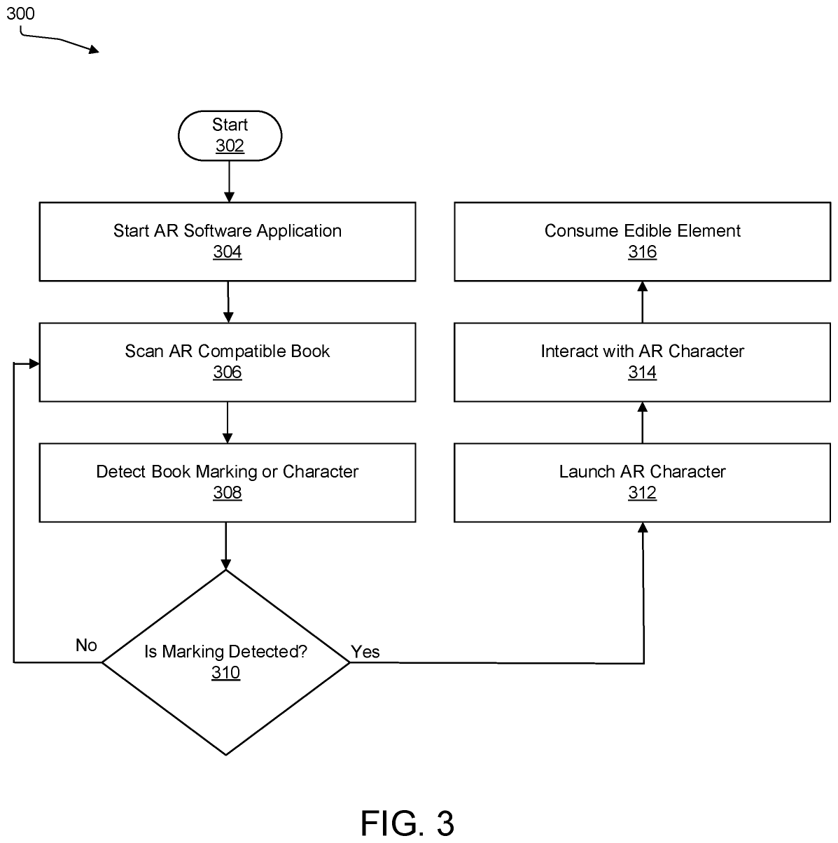

FIG. 3 illustrates an example of a process 300 for implementing an augmented reality and edible element reading system, according to some aspects of the disclosed technology. The process 300 starts at step 302 which may occur after a user installs (e.g., downloads or receives from another source) the AR software application on an electronic device (e.g., electronic device 202).

At step 304, process 300 continues where a user may start the AR software application. For example, a software application compatible with an AR book may be launched on an electronic device. Next, process 300 continues to step 306 where a user may use the camera of the electronic device to scan the AR compatible book. For example, a user may point the camera of the electronic device to a location on the page with an image or marking on the page designated to interact with the AR software application.

At step 308, process 300 continues to detect a book marking or character on the AR book. For example, there may be a specific marking, pattern, character or other image that AR software application is configured to recognize. Next, process 300 continues to decision block 310 to determine whether a marking is detected. If a marking is not detected (e.g., the camera is pointed at an incorrect location without a marking), the process 300 returns to step 306 where the user may continue moving the camera until a marking is detected. If a marking is detected, the process may continue to step 312.

At step 312, process 300 may launch an AR character associated with the marking detected at decision block 310. For example, there may be one or more markings on the AR book where each marking may launch a different AR character. In some examples, the marking may launch any type of AR animation and not only AR characters (e.g., the AR character may be any type of animation including, but not limited to, a building, structure, object, character). In some cases, the AR software application may include a pop-up message or dialog box for the user to confirm whether or not to launch the AR character.

At step 314, process 300 continues to interact with the AR character. For example, the user may interact with the character using the electronic device. In some cases, if the user is wearing smart glasses, the user may interact with the AR character with eye patterns and eye movements. In another example, the user may interact with the AR character with speech commands (e.g., the user may speak into the electronic device when the AR software application is launched and the AR character may respond to the input speech or audio).

Next, process 300 continues to step 316 where the user may consume an edible element located on the AR book. The user may consume or remove an edible element attached to the AR book and one or more AR characters may react or respond to the removal of the edible element. For example, as discussed above, the AR book may include a sensor capable of detecting the presence of the edible element on the AR book.

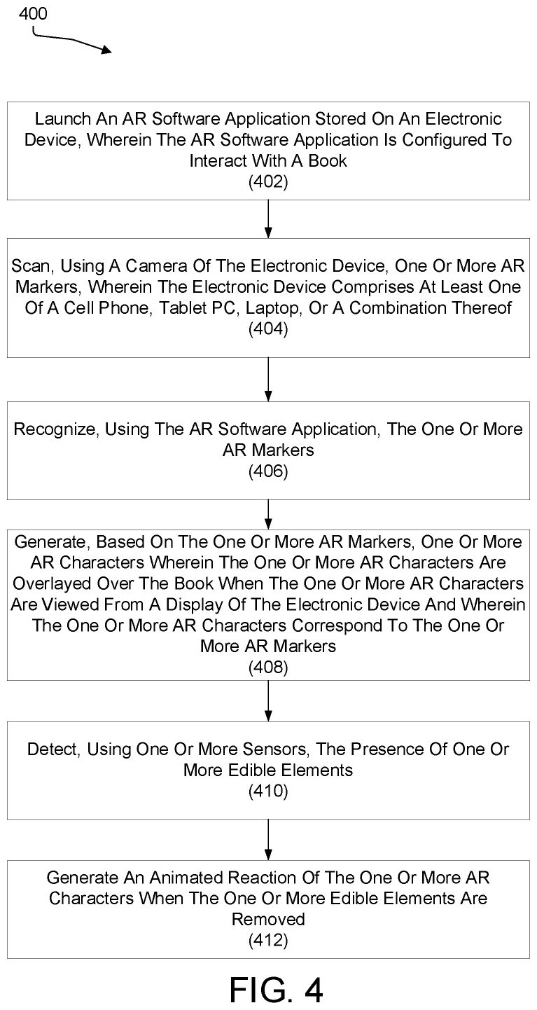

FIG. 4 illustrates another example of a process 400 for implementing an augmented reality and edible element reading system, according to some aspects of the disclosed technology.

At step 402, process 400 includes launching an AR software application stored on an electronic device, wherein the AR software application is configured to interact with a book. For example, electronic device 202 may include an AR software application configured to interact with a book 201. In other words, AR software application stored on electronic device 202 can be configured or coded to specifically work with a corresponding AR book such as children's book 201.

At step 404, process 400 includes scanning, using a camera of the electronic device, one or more AR markers, wherein the electronic device comprises at least one of a cell phone, tablet PC, laptop, or a combination thereof. For example, camera 204 located on electronic device 202 may be used to scan one or more AR markers located on book 201. The one or more AR markers in book 201 may include a character, image, pattern, QR code, or any type of image or visual marker that is configured to be recognized by the AR software application.

At step 406, process 400 includes recognizing, using the AR software application, the one or more AR markers. For example, the AR software application on electronic device 202 may recognize or be coded for recognizing specific AR markers in the pages (e.g., embedded within the pages) of book 201.

At step 408, process 400 includes generating, based on the one or more AR markers, one or more AR characters wherein the one or more AR characters are overlayed over the book when the one or more AR characters are viewed from a display of the electronic device and wherein the one or more AR characters correspond to the one or more AR markers. For example, the AR software application stored on electronic device 202 may generate one or more AR characters 206 corresponding to an AR marker embedded or located in the pages of book 201. For example, one AR marker may generate one type of character, another AR marker another character and so forth. As described above, the term AR character 206 used herein may include other animations, objects or images in addition to characters. When viewed through display 214 of electronic device 202, the user may move electronic device 202 over book 201 and the AR character 206 that was scanned based on the corresponding AR marker may appear overlayed or on top of book 201. In some aspects, more than one AR character 206 may appear simultaneously on top of book 201 (e.g., if the user scans more than one AR marker using the AR software application).

At step 410, process 400 includes detecting, using one or more sensors, the presence of the one or more edible elements. For example, there may be a sensor located in region 212 where edible element 210 is stored or attached to book 201 (e.g., attached to a page of book 201). In other words, a sensor may be directly beneath edible element 210.

At step 412, process 400 includes generating an animated reaction of the one or more AR characters when the one or more edible elements are removed. When edible element 210 is removed, the sensor located beneath edible element 210 in the region 212 may detect that the edible element is removed. One or more of the AR characters 206 may respond or react to the removal of edible element 210. For example, AR character 206 may make a facial expression as illustrated in FIG. 2 or produce a reaction animation or audio content.

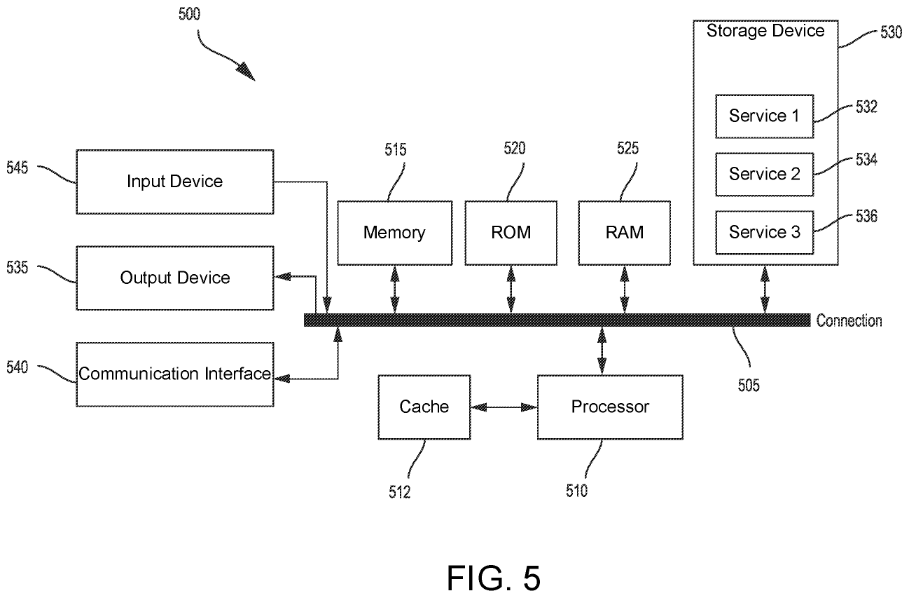

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An augmented reality and edible element reading system comprising:
an electronic device comprising a camera and a display;
a book comprising one or more augmented reality (AR) markers and one or more edible elements embedded within the pages of the book;
one or more sensors located beneath the one or more edible elements;
at least one memory; and
at least one processor coupled to the at least one memory, the at least one processor configured to:
launch an AR software application stored on the electronic device, wherein the AR software application is configured to interact with the book;
scan, using the camera of the electronic device, the one or more AR markers, wherein the electronic device comprises at least one of a cell phone, tablet PC, laptop, or a combination thereof;
recognize, using the AR software application, the one or more AR markers;
generate, based on the one or more AR markers, one or more AR characters wherein the one or more AR characters are overlayed over the book when the one or more AR characters are viewed from the display of the electronic device and wherein the one or more AR characters correspond to the one or more AR markers;
detect, using the one or more sensors, the presence of the one or more edible elements;
generate an animated reaction of the one or more AR characters when the one or more edible elements are removed.

2. The augmented reality and edible element reading system of claim 1, wherein one or more edible elements comprises at least one of chocolate, gummy, hard candy, sour candy, licorice, or a combination thereof;

3. The augmented reality and edible element reading system of claim 1, further comprising one or more cut-out regions corresponding to the one or more edible elements.
